(19) United States
(12) Patent Application Publication
(10) Pub. No.: US 2003/0081007 A1
(43) Pub. Date: May 1, 2003

(54) Object oriented explorer type environment

(76) Inventors: James Cyr, Clinton, CT (US); Channell Green, Bpt, CT (US); Martin Hold, Fairfield, CT (US); Regina Kuhnen, Trumbell, CT (US); Andrew MacGinite, Roxbury, CT (US)

Correspondence Address: HOWREY SIMON ARNOLD & WHITE LLP, BOX 34, 1299 PENNSYLVANIA AVENUE NW, WASHINGTON, DC, 20004, US

(21) Appl. No.: 09/984,875

(22) Filed: Oct. 31, 2001

(51) Int. Cl. G09G 5/00

(52) U.S. Cl. 345/804

(57) ABSTRACT

An object oriented Explorer type environment includes a first pane and a second pane linked such that one may interact with the first pane to call up data within the second pane. The first pane includes a plurality of objects, each object including a control object defined to call up a static method upon activation of the object. The static method calls up data in the second pane for viewing by an operator of the Explorer type environment.

### BACKGROUND OF THE INVENTION

1. Field of the Invention

The invention relates to a graphical using interface. More particularly, the invention relates to a Microsoft Explorer type interface in which left and right panes are dynamically linked.

2. Description of the Prior Art

The Microsoft Explorer interface has become a popular mechanism for retrieving and viewing files. As those skilled in the art will certainly appreciate, the Explorer interface includes a left pane in which a tree view control application operates to provide users with a convenient list of available files within a system. The user may click on files listed within the left pane so as to retrieve and display the file contents within the right pane. When one attempts to retrieve files designated by icons (or objects) maintained within the tree view control application of the left pane, the computer processes the requested object, performs actions in retrieving the required information from an associated data structure, returns the retrieved information to the Explorer environment and displays the information upon the right pane of the Explorer environment.

While this is a convenient mechanism for retrieving and working with simple files, use of the Explorer environment can be rather cumbersome when one attempts to create a dynamic tree view control application using Microsoft Foundation Classes. The Microsoft Foundation Class Library (MFC) is an “application framework” for programming in Microsoft Windows. Written in C++, MFC provides much of the code necessary for managing windows, menus, and dialog boxes; performing basic input/output; storing collections of data objects; and so on.

The MFC framework allows developers to build upon the work of other programmers for Windows. MFC is used as an aid in shortening development time; making code more portable; providing support without reducing programming freedom and flexibility; and giving access to “hard to program” user-interface elements and technologies, like Active technology, OLE, and Internet programming. Furthermore, MFC may be used to simplify database programming through Data Access Objects (DAO) and Open Database Connectivity (ODBC), and network programming through Windows Sockets. MFC also helps in programming features like property sheets (“tab dialogs”), print preview, and floating, customizable toolbars.

However, use of the MFC library in the creation of a dynamic tree view control application requires that the application document class keep track of the tree item being accessed and update the views after the user changes a selected item. This procedure is inconvenient and oftentimes difficult for those developers working in the Explorer environment.

With this in mind, the present invention provides a new approach to working within the Explorer environment. The environment developed in accordance with the present invention leads to improved usability and functionality within the Explorer environment.

### SUMMARY OF THE INVENTION

It is, therefore, an object of the present invention to provide an object oriented Explorer type environment including a first pane and a second pane. The first pane and second pane are linked such that one may interact with the first pane to call up data within the second pane. The first pane includes a plurality of objects, each object including a control object defined to call up a static method upon activation of the object. The static method calls up data in the second pane for viewing by an operator of the Explorer type environment.

It is also an object of the present invention to provide an environment wherein each of the plurality of objects is associated with an icon within the first pane.

It is another object of the present invention to provide an environment wherein activation is initiated by clicking on one of the plurality of objects with a cursor.

It is also another object of the present invention to provide an environment wherein different static methods a called based upon the manner in which an operator clicks on one of the plurality of objects.

It is a further object of the present invention to provide an environment wherein the cursor is controlled my a mouse including left and right buttons, and different static methods are called upon by single clicking the left button of the mouse, double clicking the left button of the mouse, single clicking the right button of the mouse and double clicking the right button of the mouse.

It is also a further object of the present invention to provide an environment wherein the first pane and second pane are respectively the left pane and right pane of a single window.

It is still a further object of the present invention to provide an environment wherein the first pane provides an operator with a tree view control application.

It is also an object of the present invention to provide an environment wherein the second pane provides an operator with a list view control application.

It is another object of the present invention to provide an environment wherein each of the plurality of objects under the tree view control application is permanently and directly linked with specific data under the list view control application of the second pane.

It is a further object of the present invention to provide an environment wherein the second pane provides an operator with a list view control application.

It is yet another object of the present invention to provide an environment wherein each of the plurality of objects associated with icons is respectively instantiated with a control object.

It is also an object of the present invention to provide an environment wherein each of the plurality of objects associated with icons is permanently and directly linked with specific data shown in the second pane.

It is also an object of the present invention to provide a method for linking a first pane and a second pane within an Explorer type environment. The method is achieved by defining at least one object within the first pane, creating a control object defined to call up a static method, the static method calling up data in the second pane for viewing by an operator of the Explorer type environment, and assigning the control object to the at least one object, wherein the control object is defined to call up the static method upon activation of the object, the static method calling up data in the second pane for viewing by an operator of the Explorer type environment.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is an Explorer type environment in accordance with the present invention prior to activation of the right pane list view control application.

FIG. 2 is an Explorer type environment in accordance with the present invention with the right pane list view control application activated.

FIG. 3 is a schematic showing the class structure utilized in accordance with the present invention.

FIG. 4 is a flow chart showing an overview of operations in accordance with the present invention.

### DESCRIPTION OF THE PREFERRED EMBODIMENT

The detailed embodiment of the present invention is disclosed herein. It should be understood, however, that the disclosed embodiment is merely exemplary of the invention, which may be embodied in various forms. Therefore, the details disclosed herein are not to be interpreted as limited, but merely as the basis for the claims and as a basis for teaching one skilled in the art how to make and/or use the invention.

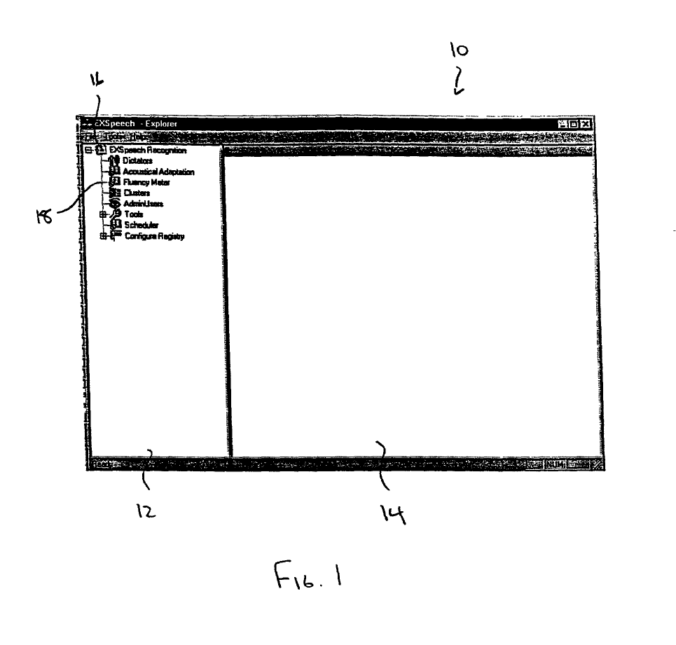

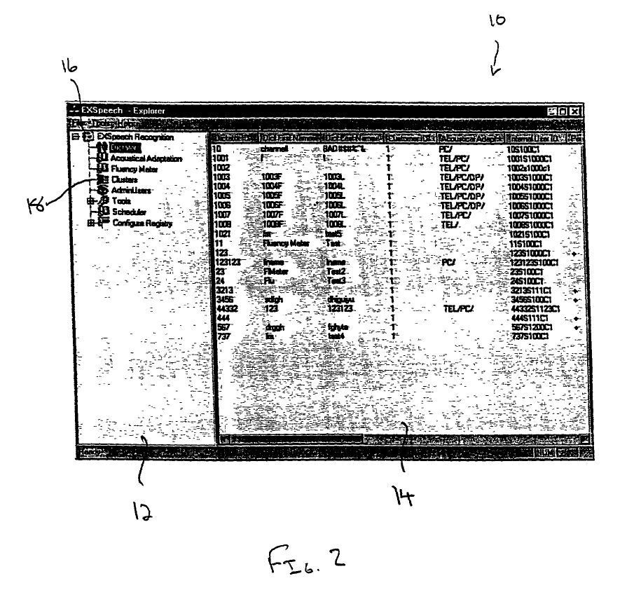

With reference to FIGS. 1 and 2, the Microsoft Explorer environment 10 utilized in accordance with the present invention is disclosed. As those skilled in the art will readily appreciate many of the terms used throughout the body of the present description relate to functionalities included in the tradition Microsoft Explorer environment. As such, unless specific reference is made to the fact that certain functionalities relate to the present invention, and are therefore not part of the conventional Microsoft Explorer environment, those skilled in the art should consider the terminology used herein to be consistent with the common understanding of those familiar with the Microsoft Explorer product.

As briefly discussed above in the Background of the Invention, the Explorer environment generally includes a left pane 12 and a right pane 14. The left pane 12 provides the operator with a tree view control application operating to provide users with a convenient list of available files within a system. Those skilled in the art will certainly understand that the tree view control application maintained in the left pane 12 is composed of a series of files 16 and subfiles 18 which are readily and selectively compressed and expanded as an operator accesses desired information. While the Explorer environment shown in accordance with a preferred embodiment of the present invention includes left and right panes, those skilled in the art will certainly appreciate that panes of different shapes, positions and orientations may be employed within the spirit of the present invention.

More specifically, the tree view control application displays a hierarchical list of node objects, each of which consists of a label and an optional bitmap. The tree view control application of the left pane 12 is typically used to display the headings in a document, the entries in an index, the files and directories on a disk, or any other kind of information that might usefully be displayed as a hierarchy.

After creating a tree view control application, a developer may add, remove, arrange, and otherwise manipulate node objects by setting properties and invoking methods. The developer may programmatically expand and collapse node objects to display or hide all child nodes. Three events, the Collapse, Expand, and NodeClick event, also provide programming functionality.

The developer may also navigate through a tree in code by retrieving a reference to node objects using root, parent, child, first sibling, next, previous, and last sibling properties. Users can navigate through a tree using the keyboard as well. UP ARROW and DOWN ARROW keys cycle downward through all expanded node objects. Node objects are selected from left to right, and top to bottom. At the bottom of a tree, the selection jumps back to the top of the tree, scrolling the window if necessary. RIGHT ARROW and LEFT ARROW keys also tab through expanded node objects, but if the RIGHT ARROW key is pressed while an unexpanded node is selected, the node expands; a second press will move the selection to the next node. Conversely, pressing the LEFT ARROW key while an expanded node has the focus collapses the node. If a user presses an ANSI key, the focus will jump to the nearest node that begins with that letter. Subsequent pressings of the key will cause the selection to cycle downward through all expanded nodes that begin with that letter.

Several styles are available which alter the appearance of the tree view control application. Node objects can appear in one of eight combinations of text, bitmaps, lines, and plus/minus signs.

The tree view control application of the left pane 12 uses the image list control, specified by the image list property, to store the bitmaps and icons that are displayed in node objects. A tree view control application can use only one image list at a time. This means that every item in the tree view control application will have an equal-sized image next to it when the tree view control application's style property is set to a style which displays images.

The right pane 14 provides operators with a list view of the information selected based upon the file selected within the left pane 12, or tree view control application. In accordance with the underlying Microsoft Explorer environment, the list view control application, i.e., the application operating in the right pane 14 of the Microsoft Explorer environment, is part of a group of Active X controls found in the MCCOMCTL.OCX file of Microsoft Explorer.

More specifically, the list view control application displays items using one of four different views. A developer may arrange items into columns with or without column headings as well as display accompanying icons and text. With a list view control application, a developer is able to organize list entries, called ListItem objects, into one of four different views: (1) Large (standard) Icons, (2) Small Icons, (3) List and (4) Report.

The view property determines which view the list view controller uses to display the items in the list of the right pane 14. The developer can also control whether the labels associated with items in the list wrap to more than one line using the LabelWrap property of Microsoft Explorer. In addition, developers can manage how items in the list are sorted and how selected items appear. The list view control application contains ListItem and ColumnHeader objects. A ListItem object defines the various characteristics of items in the list view control application, such as, a brief description of the item, icons that may appear with the item, supplied by an ImageList control, and additional pieces of text, called subitems, associated with a ListItem object that you can display in Report view.

The developer may also display column headings in the list view control application using the HideColumnHeaders property. They can be added at both design and run time. At design time, the developer may use the column headers tab of the list view control application properties dialog box. At run time, the developer will use the Add method to add a ColumnHeader object to the ColumnHeaders collection.

The present invention employs object oriented programmning techniques facilitated through the application of C++ to link the left and right panes 12, 14 of the Explorer environment 10 in a manner which “marries” the list view control application of the right pane 14 to the tree view control application of the left pane 12. As those skilled in the art will certainly appreciate, object-oriented programming (OOP) is organized around “objects” rather than “actions,” data rather than logic. Historically, a program has been viewed as a logical procedure that takes input data, processes it, and produces output data. Object-oriented programming takes the view that what we really care about are the objects we want to manipulate rather than the logic required to manipulate them.

The first step in OOP is to identify all the objects the operator wants to manipulate and how they relate to each other, an exercise often known as data modeling. Once the operator has identified an object, the operator generalizes it as a class of objects and defines the kind of data it contains and any logic sequences that can manipulate it. Each distinct logic sequence is known as a method. A real instance of a class is called an “object” or, in some environments, an “instance of a class.” The object or class instance is what is run in the computer. Its methods provide computer instructions and the class object characteristics provide relevant data. The operator communicates with objects, and the objects communicate with each other, with well-defined interfaces called messages.

The concepts and rules used in object-oriented programming provide these important benefits:

The concept of a data class makes it possible to define subclasses of data objects that share some or all of the main class characteristics. Called inheritance, this property of OOP forces a more thorough data analysis, reduces development time, and ensures more accurate coding.

Since a class defines only the data it needs to be concerned with, when an instance of that class (an object) is run, the code will not be able to accidentally access other program data. This characteristic of data hiding provides greater system security and avoids unintended data corruption.

The definition of a class is reusable not only by the program for which it is initially created but also by other object-oriented programs (and, for this reason, can be more easily distributed for use in networks).

The concept of data classes allows a programmer to create any new data type that is not already defined in the language itself.

With the foregoing in mind, each icon within the tree view control application represents an object which may be clicked on to perform actions as will be discussed below in greater detail. More specifically, and as defined in accordance with a preferred embodiment of the specific structure utilized in the present invention, the icons defined within the left pane 12 are created as a class of tree objects, that is, CTreeObjects. Each of the CTreeObjects includes a control object, that is, CSelCtrlObject, which defines the static methods called as the icons within the left pane 12 are clicked in various ways by the user. The static methods called upon by the clicking one of the CTreeObjects ultimately relate to certain views shown by the list view control application of the right pane 14. The clicking of icons within the left pane 12 is also referred to as a mouse event, item event, etc. within the body of the present specification, although a variety of terms may be used within the spirit of the present invention.

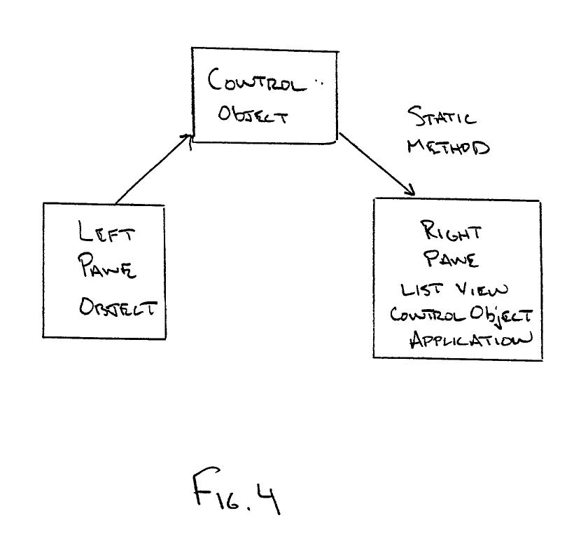

The CTreeObjects and CSelCtrlObjects are instantiated at the start of the program and permanently “marry” the list view control application of the right pane 14 to the tree view control application of the left pane 12. The processing resulting from the “marrying” of the list view control application of the right pane 14 to the tree view control application of the left pane 12 is shown in FIGS. 1, 2 and 4. FIG. 4 shows a mouse event linked to the control object, CSelCtrlObject, which then directly calls up the static method associated therewith. The static method called upon by the CSelCtrlObject is shown in the right pane 14 under the control of the list view control application. Static methods are those methods which may be used independently of any other object of that class. That is, normally a class member must be accessed only in conjunction with an object of its class. However, members may be created which may be used by itself, with reference to a specific instance. Such members are created by inserting the keyword “static” before its declaration. When a member is declared as being static, it can be accessed before any objects of its class are created, and without reference to any object. Static methods have specific characteristics providing that they can only call other static methods, they must only access static data and they cannot refer to “this” or “super” in any other way.

In accordance with a preferred embodiment of the structure employed in carrying out the present invention, by including a control object, that is, CSelCtrlObject, which defines a static method, with CTreeObjects, different static methods calling for specific actions with regard to the right pane 14 are directly called when the operator either clicks, double clicks, right clicks or double right clicks upon an icon in the left pane 12.

Associating different clicks of the various icons maintained with the tree view control application with a CSelCtrlObject defining static methods reflected in the right pane 14, allows the operator to permanently and directly link the CTreeObjects of the left pane 12 to the list view control of the right pane 14. Therefore, the ListViews data and header set data of the right pane may change dynamically as the user accesses the tree items defined by CTreeObjects, and there is no requirement that the application document class keep track of the tree item being accessed and update the views after the user changes a selected item.

By way of example, the present architecture will now be described with reference to FIGS. 1 and 2. Upon initialization of the present Explorer environment, a CTreeObject is created for each item listed within the tree view control application of the left pane 12. The level parameter shown in the left pane 12 indicates the high tree items under which other items reside.

The list of CTreeObjects for each of the items as discussed above are respectively associated with CielCtrlObject derived control objects which call up static methods acting upon the right pane 14 in the event of a mouse click event. The CSelCtrlObject derived control objects are added to the overall CTreeControlObject and the resulting tree is shown by way of example in the left pane 12 of FIG. 1.

When a user clicks on a tree item, the class handler for the CTreeObject associated with the clicked item is summoned. Clicking of the item in this way, calls up the static method associated with the specific mouse click performed by the operator. Activation of the static method causes the CSelCtrlObject derived control object, for example, by pointing to the Cselection View (a class developed specifically for implementation of the present invention), to call up the data populating the right pane 14 shown in FIG. 2. In this way, and as previously discussed above in greater detail, the objects of the left pane 12 are permanently and directly linked to the list view control application of the right pane 14.

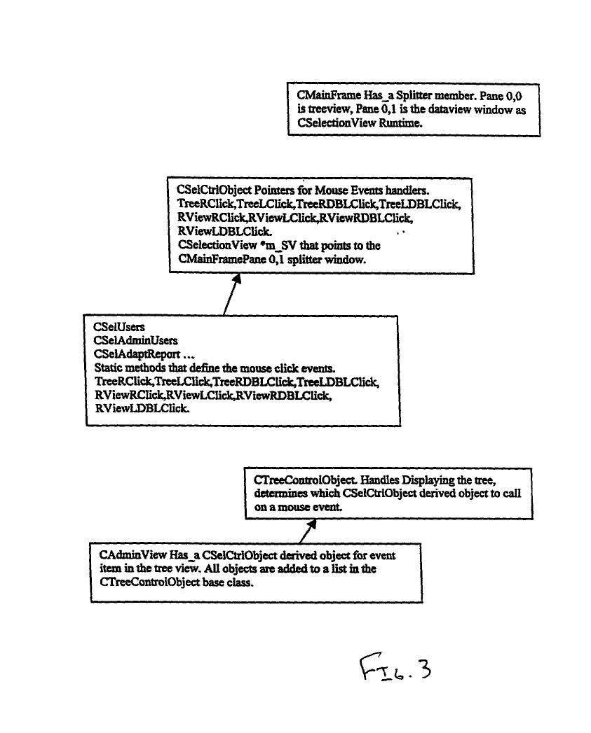

With reference to FIG. 3, a preferred embodiment of the class and object structure implemented in accordance with the present invention is presented byway of example. However, those skilled in the art will appreciate the many variations possible within the spirit of the present invention.

The underlying appearance of the screen is generally defined by a CMainFrame. The CMainFrame is provided with a splitter member. The splitter member defines the screen into Pane 0,0 which is the tree view and Pane 0,1 which is the list view window as CSelection View Runtime.

Additional defined classes includes CSelUsers, CSelAdminUsers, CSelAdaptReport. The static methods defining the various mouse click events are defined as TreeRClick, TreeLClick, TreeRDBLClick TreeLDBLClick, RViewRClick, RViewRDBLClick and RViewLDBLClick, and are intimately associated with CSelCtrlObject as discussed above. The static methods defined for the various mouse click events are lined to the CSelCtrlObject Pointers which handle the mouse events. Further provided is CSelectionView*m_SV that points to the CMainFramePane 0,1 (right pane) splitter window.

The CSelCtrlObject derived control object is part of the CAdminView. The CSelCtriObject derived control object is related to a specific mouse event item in the tree view (in fact, each event item in the tree view has a CSelCtrlObject derived control object). The call of specific CSelCtrlObject derived control objects is under the control of the CTreeControlObject. The CTreeControlObject also handles the display of the tree.

While the preferred embodiments have been shown and described, it will be understood that there is no intent to limit the invention by such disclosure, but rather, is intended to cover all modifications and alternate constructions falling within the spirit and scope of the invention as defined in the appended claims.

1. An object oriented Explorer type environment including a first pane and a second pane, the first pane and second pane being linked such that one may interact with the first pane to call up data within the second pane, the environment comprising:
a first pane including a plurality of objects, each object including a control object defined to call up a static method upon activation of the object, the static method calling up data in the second pane for viewing by an operator of the Explorer type environment.

2. The environment according to claim 1, wherein each of the plurality of objects is associated with an icon within the first pane.

3. The environment according to claim 2, wherein activation is initiated by clicking on one of the plurality of objects with a cursor.

4. The environment according to claim 3, wherein different static methods a called based upon the manner in which an operator clicks on one of the plurality of objects.

5. The environment according to claim 4, wherein the cursor is controlled my a mouse including left and right buttons, and different static methods are called upon by single clicking the left button of the mouse, double clicking the left button of the mouse, single clicking the right button of the mouse and double clicking the right button of the mouse.

6. The environment according to claim 1, wherein activation is initiated by clicking on one of the plurality of objects with a cursor.

7. The environment according to claim 6, wherein different static methods a called based upon the manner which an operator clicks on one of the plurality of objects.

8. The environment according to claim 7, wherein the cursor is controlled my a mouse including left and right buttons, and different static methods are called upon by single clicking the left button of the mouse, double clicking the left button of the mouse, single clicking the right button of the mouse and double clicking the right button of the mouse.

9. The environment according to claim 1, wherein the first pane and second pane are respectively the left pane and right pane of a single window.

10. The environment according to claim 1, wherein the first pane provides an operator with a tree view control application.

11. The environment according to claim 10, wherein the second pane provides an operator with a list view control application.

12. The environment according to claim 11, wherein each of the plurality of objects under the tree view control application is permanently and directly linked with specific data under the list view control application of the second pane.

13. The environment according to claim 1, wherein the second pane provides an operator with a list view control application.

14. The environment according to claim 1, wherein each of the plurality of objects associated with icons is respectively instantiated with a control object.

15. The environment according to claim 1, wherein each of the plurality of objects associated with icons is permanently and directly linked with specific data shown in the second pane.

16. A method for linking a first pane and a second pane within an Explorer type environment, comprising the following steps:
defining at least one object within the first pane;
creating a control object defined to call up a static method, the static method calling up data in the second pane for viewing by an operator of the Explorer type environment;
assigning the control object to the at least one object, wherein the control object is defined to call up the static method upon activation of the object, the static method calling up data in the second pane for viewing by an operator of the Explorer type environment.

17. The method according to claim 16, further including a plurality of objects and wherein the step of defining includes associating each object with an icon within the first pane.

18. The method according to claim 17, wherein activation is initiated by clicking on the object with a cursor.

19. The method according to claim 18, wherein different static methods a called based upon the manner in which an operator clicks on the object.

20. The method according to claim 19, wherein the cursor is controlled my a mouse including left and right buttons, and different static methods are called upon by single clicking the left button of the mouse, double clicking the left button of the mouse, single clicking the right button of the mouse and double clicking the right button of the mouse.

21. The method according to claim 16, wherein activation is initiated by clicking on the object with a cursor.

22. The method according to claim 20, wherein different static methods a called based upon the manner in which an operator clicks on the object.

23. The method according to claim 21, wherein the cursor is controlled my a mouse including left and right buttons, and different static methods are called upon by single clicking the left button of the mouse, double clicking the left button of the mouse, single clicking the right button of the mouse and double clicking the right button of the mouse.

24. The method according to claim 16, wherein the first pane and second pane are respectively the left pane and right pane of a single window.

25. The method according to claim 16, wherein the first pane provides an operator with a tree view control application.

26. The method according to clam 25, wherein the second pane provides an operator with a list view control application.

27. The method according to claim 26, further including a plurality of objects and the step of permanently and directly linking each object under the tree view control application with specific data under the list view control application of the second pane.

28. The method according to claim 16, wherein the second pane provides an operator with a list view control application.

29. The method according to claim 16, wherein step of assigning further includes instantiating respective the object associated with the icon with a control object.

30. The method according to claim 16, further including a plurality of objects and the step of permanently and directly linking each object associated with icons with specific data shown in the second pane.
